(19) United States
(12) Patent Application Publication
(10) Pub. No.: US 2024/0414158 A1
(43) Pub. Date: Dec. 12, 2024

(54) NETWORK CONFIGURATION DEVICE, INFORMATION SYSTEM, NETWORK CONFIGURATION METHOD, AND RECORDING MEDIUM

(71) Applicant: NEC Corporation, Minato-ku, Tokyo (JP)

(72) Inventors: Yoshiaki SAKAE, Tokyo (JP); Jun NISHIOKA, Tokyo (JP)

(73) Assignee: NEC Corporation, Minato-ku, Tokyo (JP)

(21) Appl. No.: 18/699,355

(22) PCT Filed: Nov. 12, 2021
(86) PCT No.: PCT/JP2021/041669

§ 371 Date: Apr. 8, 2024

(51) Int. Cl. H04L 9/40

(52) U.S. Cl. CPC H04L 63/0876

(57) ABSTRACT

A network configuration device according to the present disclosure is provided with: a device-information acquisition means for acquiring visualized device information about a configuration and a risk regarding a network device connected to a physical network; an authenticity determination means for determining authenticity of the network device on the basis of the acquired device information; and a network configuration means for configuring a virtual network on the physical network on the basis of a result of determination made as to the authenticity of the network device.

### TECHNICAL FIELD

The present disclosure relates to a network configuration device, an information system, a network configuration method, and a recording medium.

### BACKGROUND ART

Communication services in response to diverse needs of users, such as use of high-quality lines with no interruption of data communication, are operated in a network. In relation to this, there is a technique called network slicing that selects and operates a slice for each service in a plurality of virtual networks in the network.

For example, PTL 1 discloses a network service management device that determines a resource to be allocated to a virtual network, the resource implementing a function that matches a resource requirement of a virtual network function included in a network service.

### CITATION LIST

### Patent Literature

PTL 1: JP 2020-36105 A

### SUMMARY OF INVENTION

### Technical Problem

However, the invention disclosed in PTL 1 does not consider authenticity of the resource to be allocated to the virtual network. Thus, there is a risk in terms of security at a time of providing a communication service.

An example of an object of the present disclosure is to provide a network configuration device capable of configuring a virtual network while ensuring network security.

### Solution to Problem

A network configuration device according to an aspect of the present disclosure includes a device information acquisition means that obtains device information in which a configuration and a risk regarding a network device connected to a physical network are visualized, an authenticity determination means that determines authenticity of the network device based on the obtained device information, and a network configuration means that configures a virtual network on the physical network based on a result of the determination on the authenticity of the network device.

An information system according to an aspect of the present disclosure includes a network configuration device, a service slicing management device that manages and controls the network configuration device, and a device information storage device that stores device information in which a configuration and a risk regarding a network device connected to a physical network are visualized, in which the network configuration device includes a device information acquisition means that obtains the device information from the device information storage device, an authenticity determination means that determines authenticity of the network device based on the obtained device information, and a network configuration means that configures a virtual network on the physical network based on a result of the determination on the authenticity of the network device.

A network configuration method according to an aspect of the present disclosure includes obtaining device information in which a configuration and a risk regarding a network device connected to a physical network are visualized, determining authenticity of the network device based on the obtained device information, and configuring a virtual network on the physical network based on a result of the determination on the authenticity of the network device.

A recording medium according to an aspect of the present disclosure stores a program for causing a computer to perform obtaining device information in which a configuration and a risk regarding a network device connected to a physical network are visualized, determining authenticity of the network device based on the obtained device information, and configuring a virtual network on the physical network based on a result of the determination on the authenticity of the network device.

### Advantageous Effects of Invention

According to an exemplary effect of the present disclosure, it becomes possible to provide a network configuration device capable of configuring a virtual network while ensuring security.

### BRIEF DESCRIPTION OF DRAWINGS

FIG. 1 is a block diagram illustrating a configuration of a network configuration device according to a first example embodiment.

FIG. 2 is a diagram illustrating a hardware configuration in which the network configuration device according to the first example embodiment is implemented by a computer device and its peripheral devices.

FIG. 3 is a flowchart illustrating operation of the network configuration according to the first example embodiment.

FIG. 4 is a block diagram illustrating a configuration of a network configuration device according to a second example embodiment.

FIG. 5 is a flowchart illustrating operation of the network configuration according to the second example embodiment.

### EXAMPLE EMBODIMENT

Next, example embodiments will be described with reference to the drawings.

### First Example Embodiment

A network configuration device 100 according to a first example embodiment is a device for configuring a plurality of virtual networks (slices) including one physical network and performing network slicing that assigns functions necessary for a communication service. The virtual network refers to a network in which physical resources are abstracted by software and may be used by being logically grouped or divided.

The network slicing is a technique of constructing a plurality of independent slices by software according to a requirement of a communication service in end-to-end across domains while using a network device, such as a general-purpose server, a transport device, or the like, in common. By arranging resources, such as a data processing function, storage, and the like, in slices based on the network slicing technique, it becomes possible to construct communication services having different requirements in the slices. The network configuration device 100 is implemented by, for example, a plurality of resource controllers that manages and controls various devices for each domain (e.g., wireless access, transport, and core).

An information system 10 according to the present example embodiment includes the network configuration device 100, a service slicing management device 200 that manages and controls the network configuration device 100, and a device information storage device 300 that stores device information in which a configuration and a risk regarding a network device connected to the network are visualized.

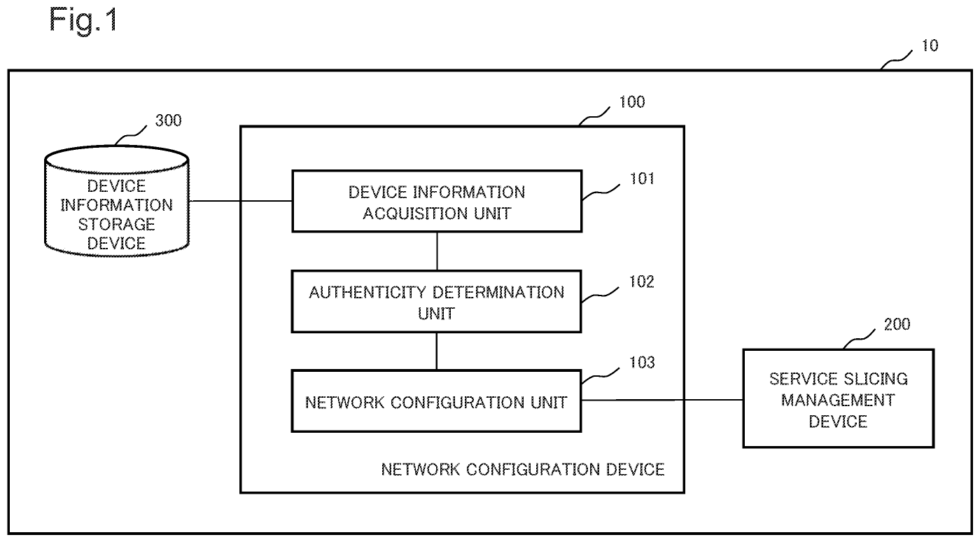

FIG. 1 is a block diagram illustrating a configuration of the network configuration device 100 according to the first example embodiment. With reference to FIG. 1, the network configuration device 100 includes a device information acquisition unit 101, an authenticity determination unit 102, and a network configuration unit 103. Hereinafter, the network configuration device 100, which is an essential configuration of the present example embodiment, will be described in detail.

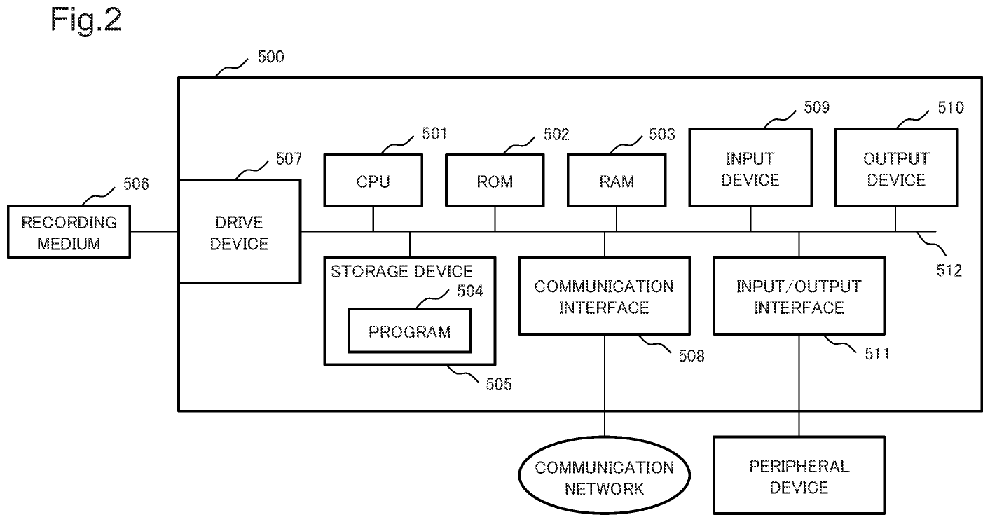

FIG. 2 is a diagram illustrating an exemplary hardware configuration in which the network configuration device 100 according to the first example embodiment of the present disclosure is implemented by a computer device 500 including a processor. As illustrated in FIG. 2, the network configuration device 100 includes a central processing unit (CPU) 501, a read only memory (ROM) 502, a memory such as a random access memory (RAM) 503, a storage device 505 such as a hard disk that stores a program 504, a communication interface (I/F) 508 for network connection, and an input/output interface 511 that inputs and outputs data. In the first example embodiment, the device information obtained by the device information acquisition unit 101 is input to the network configuration device 100 via the input/output interface 511.

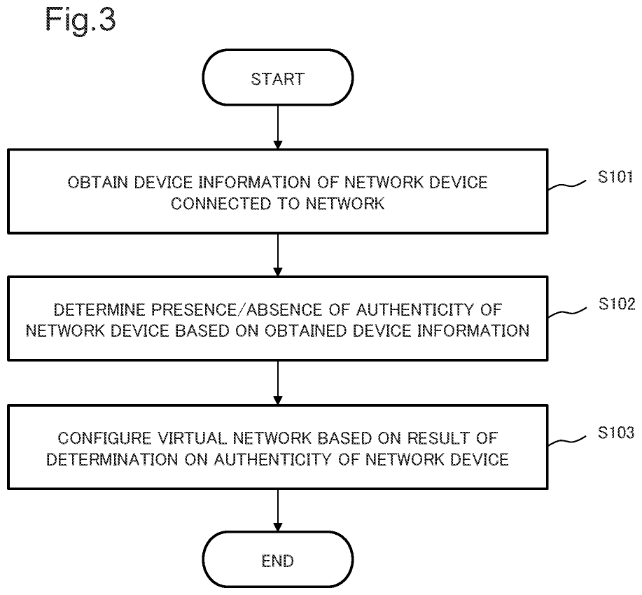

The CPU 501 operates an operating system and controls the entire network configuration device 100 according to the first example embodiment of the present invention. The CPU 501 reads, to the memory, a program and data from a recording medium 506 attached to, for example, a drive device 507 or the like. The CPU 501 functions as the device information acquisition unit 101, the authenticity determination unit 102, the network configuration unit 103, and a part thereof in the first example embodiment, and executes processing or a command in a flowchart illustrated in FIG. 3 to be described later based on the program.

The recording medium 506 is, for example, an optical disk, a flexible disk, a magneto-optical disk, an external hard disk, a semiconductor memory, or the like. A part of the recording medium of the storage device is a non-volatile storage device, and records the program therein. The program may be downloaded from an external computer (not illustrated) connected to a communication network.

An input device 509 is implemented by, for example, a mouse, a keyboard, a built-in key button, and the like, and is used for input operation. The input device 509 is not limited to a mouse, a keyboard, and a built-in button, and may be a touch panel, for example. An output device 510 is implemented by, for example, a display, and is used to confirm an output.

As described above, the first example embodiment illustrated in FIG. 1 is achieved by the computer hardware illustrated in FIG. 2. However, the means for implementing the units included in the network configuration device 100 in FIG. 1 is not limited to the configuration described above. The network configuration device 100 may be implemented by one physically coupled device, or may be implemented by a plurality of devices in which two or more physically separated devices are coupled by wire or wirelessly. For example, the input device 509 and the output device 510 may be coupled to the computer device 500 via a network. The network configuration device 100 according to the first example embodiment illustrated in FIG. 1 may be configured by cloud computing or the like.

In FIG. 1, the device information acquisition unit 101 is a means that obtains device information in which a configuration and a risk regarding a network device connected to the network are visualized. The network includes a physical network and a plurality of virtual networks constructed on the physical network. The device information acquisition unit 101 obtains, from the device information storage device 300, device information of each network device connected to the network. There may be a single or a plurality of the network devices on the network.

In the present example embodiment, the device information indicates information required to determine authenticity of the network device, and includes different types of device information such as configuration information, event information, and inspection information. The event information and the inspection information indicate information in which the risk of the network device is visualized. Here, pieces of the device information stored in the device information storage device 300 will be described. In the device information storage device 300, for example, the configuration information, the event information, and the inspection information are stored for each network device together with time at which the information is obtained.

The configuration information is, for example, hardware information and software information of the network device. The hardware information includes manufacturer information, model numbers of a chip, a substrate, a port, and the like included in the hardware, an identifier assigned to the hardware, and the like. The software information includes manufacturer information, a software name of an operating system (OS) that processes the hardware, a library, an application, or the like, version information or a hash value of the software, and the like. The hash value is a value calculated from data including software binaries and the like, and may be used to confirm identity with software distributed from a manufacturer by being compared with a hash value distributed from the software manufacturer. Information of the configuration information is updated at timing when the configuration information, such as timing of a version upgrade of the software, is updated.

The event information is, for example, log information that has occurred in the network device. For example, packet communication information such as communication data volume, a communication error rate, the number of times of packet retransmission, or the like of each network port connected to the network device is stored as the log information. Information of the event information is updated at intervals of several seconds, for example.

The inspection information is information related to a result of inspection and analysis performed based on the configuration information and the event information of the device to be monitored. A result of the presence or absence of the authenticity of the device is stored as an inspection result in association with time information. The inspection information is updated at each timing when the configuration changes, such as a version upgrade of the software of the network device, or when the event information largely changes.

The authenticity determination unit 102 is a means that determines the authenticity of the network device based on the device information obtained by the device information acquisition unit 101. In the present example embodiment, the authenticity indicates a state where settings and the like of the hardware information and software information of the network device are not erased, falsified, replaced, or the like. First, the authenticity determination unit 102 determines the authenticity of the network device using a publicly known method for each piece of the configuration information, the event information, and the inspection information, and outputs pieces of authenticity individual information, which are determination results.

Regarding the configuration information, for example, the authenticity determination unit 102 determines whether there is authenticity based on a difference between the configuration information at the time when the system is delivered and the configuration information stored in the device information storage device 300. Regarding the event information, for example, the authenticity determination unit 102 determines whether there is authenticity based on the event information of a normal value and the event information stored in the device information storage device 300. Regarding the inspection information, for example, the authenticity determination unit 102 determines whether there is authenticity based on an analysis result of the inspection and whether the inspection is carried out.

Next, the authenticity determination unit 102 comprehensively determines the authenticity of the network device based on the authenticity individual information, which is the authenticity determination result of each of the configuration information, the event information, and the inspection information. The authenticity determination unit 102 outputs authenticity information as an authenticity determination result. The authenticity information is information indicating whether the authenticity is ensured, and may be represented by a binary of presence or absence of the authenticity. Alternatively, the authenticity information may be represented by a numerical value (score) such as 0 to 100%.

For example, when the authenticity information is represented by the presence or absence of the authenticity, the authenticity determination unit 102 determines that the network device has the authenticity if all of the configuration information, the event information, and the inspection information of the network device have the authenticity. If none of the pieces of information in the device information of the network device has the authenticity, the authenticity determination unit 102 determines that the network device has no authenticity. If the device information of the network device includes information with the authenticity and information without the authenticity, the authenticity determination unit 102 determines that there is the authenticity depending on the number of pieces of information determined to have the authenticity and a type of the information determined to have the authenticity. For example, the authenticity determination unit 102 determines that there is the authenticity if the event information and the inspection information are determined to have the authenticity while the configuration information is determined not to have the authenticity. However, the method of determining the authenticity by the authenticity determination unit 102 is not limited thereto.

The network configuration unit 103 is a means that configures a virtual network based on the device authenticity determination result determined by the authenticity determination unit 102. The network configuration unit 103 configures a virtual network using only the network device determined to have the authenticity by the authenticity determination unit 102. On the other hand, the network configuration unit 103 incorporates, into the virtual network, the network device determined not to have the authenticity by the authenticity determination unit 102. The network configuration unit 103 further transmits, to the service slicing management device 200, information regarding the network device incorporated in the virtual network.

Operation of the network configuration device 100 configured as described above will be described with reference to a flowchart of FIG. 3.

FIG. 3 is a flowchart illustrating an outline of the operation of the network configuration device 100 according to the first example embodiment. The process according to this flowchart may be executed based on program control by the processor described above.

As illustrated in FIG. 3, first, the device information acquisition unit 101 obtains the device information of the network device connected to the network (step S101). Next, the authenticity determination unit 102 determines the authenticity of the network device based on the device information obtained by the device information acquisition unit 101 (step S102). Finally, the network configuration unit 103 configures a virtual network based on an authenticity determination result determined by the authenticity determination unit 102 (step S103). The network configuration device 100 then terminates the operation of the network configuration.

In the network configuration device 100 according to the present example embodiment, the network configuration unit 103 configures a virtual network based on the authenticity determination result determined by the device information acquisition unit 101. As a result, the network configuration device 100 is enabled to configure the virtual network using the network device in which the authenticity is ensured, whereby it becomes possible to configure the network while ensuring security.

A variation of the present example embodiment will be described. In the present example embodiment, the authenticity determination unit 102 first determines, by a publicly known method, the authenticity of the network device for each piece of the configuration information, the event information, and the inspection information, and comprehensively determines the authenticity of the network device based on the authenticity individual information, which is each result of the authenticity determination. However, the authenticity determination unit 102 may obtain pieces of the authenticity individual information determined by the network device based on various types of device information, and may determine the authenticity of the network device based on the obtained authenticity individual information.

### Second Example Embodiment

Next, a second example embodiment of the present disclosure will be described in detail with reference to the drawings. Hereinafter, descriptions of contents that overlap with the descriptions above will be omitted to the extent that the description of the present example embodiment is not unclear. In a similar manner to the computer device illustrated in FIG. 2, functions of components in the example embodiments of the present disclosure may be implemented not only by hardware but also by a computer device or software based on program control.

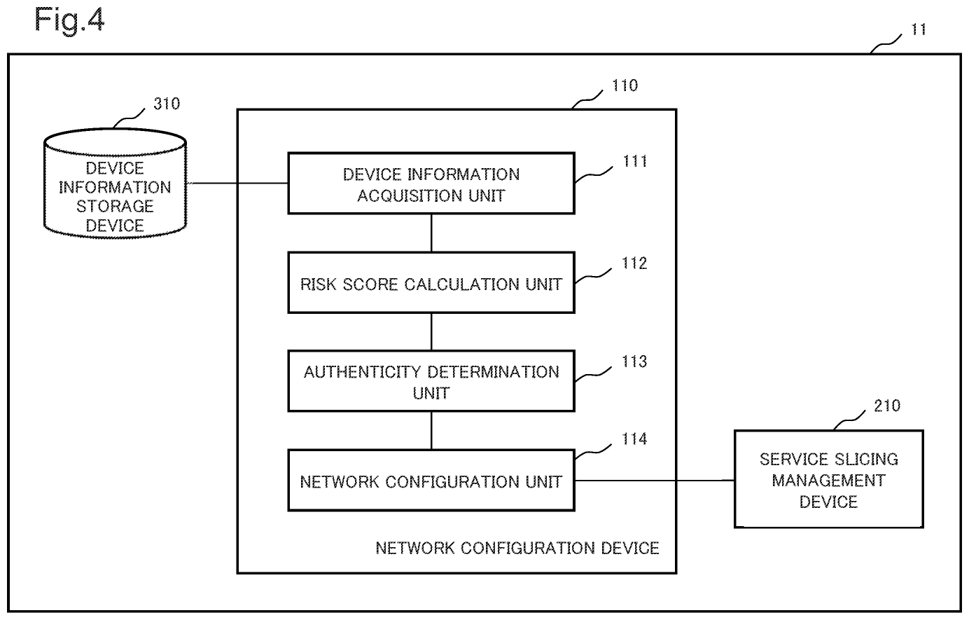

FIG. 4 is a block diagram illustrating a configuration of a network configuration device 110 according to the second example embodiment of the present disclosure. The network configuration device 110 according to the second example embodiment will be described focusing on portions different from those of the network configuration device 100 according to the first example embodiment with reference to FIG. 4. The network configuration device 110 according to the second example embodiment includes a device information acquisition unit 111, a risk score calculation unit 112, an authenticity determination unit 113, and a network configuration unit 114. That is, the present example embodiment is different from the first example embodiment in that the risk score calculation unit 112 is included.

The device information acquisition unit 111 according to the second example embodiment obtains device information when device information of a network device incorporated in a virtual network is updated. The time when the device information is updated indicates timing at which the device information is updated. When the device information in a device information storage device 310 is updated, the device information acquisition unit 111 receives information indicating that the device information is updated from the device information storage device 310. The device information acquisition unit 111 may sequentially monitor the information in the device information storage device 310, and may detect that the device information in the device information storage device 310 is updated. The method of obtaining the device information by the device information acquisition unit 111 is similar to that of the device information acquisition unit 101.

The risk score calculation unit 112 is a means that calculates a risk score, which is a degree of authenticity, based on the device information. The risk score calculation unit 112 calculates a risk score based on pieces of information of configuration information, event information, and inspection information of the network device. First, the risk score calculation unit 112 scores the authenticity of each piece of information by a publicly known method based on the device information obtained by the device information acquisition unit 111. Specifically, regarding the configuration information, the risk score calculation unit 112 increases the score if it is closer to the configuration information (hardware and software) at the time of delivery, and decreases the score as the number of different portions increases. The risk score calculation unit 112 may score the software configuration information by comparing it with the configuration information at the time of update instead of the configuration information at the time of delivery. That is, the score increases if the software configuration information is closer to the software configuration information at the time of update, and the score decreases as the number of different portions increases. Regarding the event information, the risk score calculation unit 112 increases the score if it is closer to a normal value, and decreases the score as a different portion becomes larger. The risk score calculation unit 112 scores the inspection information according to an inspection result.

The risk score calculation unit 112 scores the risk score based on the pieces of information of the configuration information, the event information, and the inspection information by the method described above. Next, the risk score calculation unit 112 calculates a risk score of the entire network device by adding numerical values of various types of authenticity information associated with the target network device using a method such as the logical sum, arithmetic average, total sum, or the like. However, the method of calculation by the risk score calculation unit 112 is not limited thereto. The risk score may be calculated using an artificial intelligence (AI) model generated based on a correlative relationship between the various types of authenticity information and an actual authenticity result. The risk score calculation unit 112 outputs the device risk score calculated in this manner to the authenticity determination unit 113.

The authenticity determination unit 113 determines the authenticity of the network device based on the risk score calculated by the risk score calculation unit 112. The authenticity determination unit 113 determines that there is the authenticity if the calculated risk score is larger than a predetermined threshold value. On the other hand, the authenticity determination unit 113 deter that there is no authenticity if the calculated risk score is not larger than the predetermined threshold value. Information regarding the threshold value is stored in a storage device 505, for example. The authenticity determination unit 113 outputs the authenticity determination result to the network configuration unit 114.

The network configuration unit 114 reconfigures the virtual network by configuring the virtual network based on the authenticity determination result determined by the authenticity determination unit 113. That is, the network configuration unit 114 excludes the network device determined not to have the authenticity by the authenticity determination unit 113 from the network configuration. The network configuration unit 114 incorporates the network device determined to have the authenticity by the authenticity determination unit 113 instead of the excluded network device.

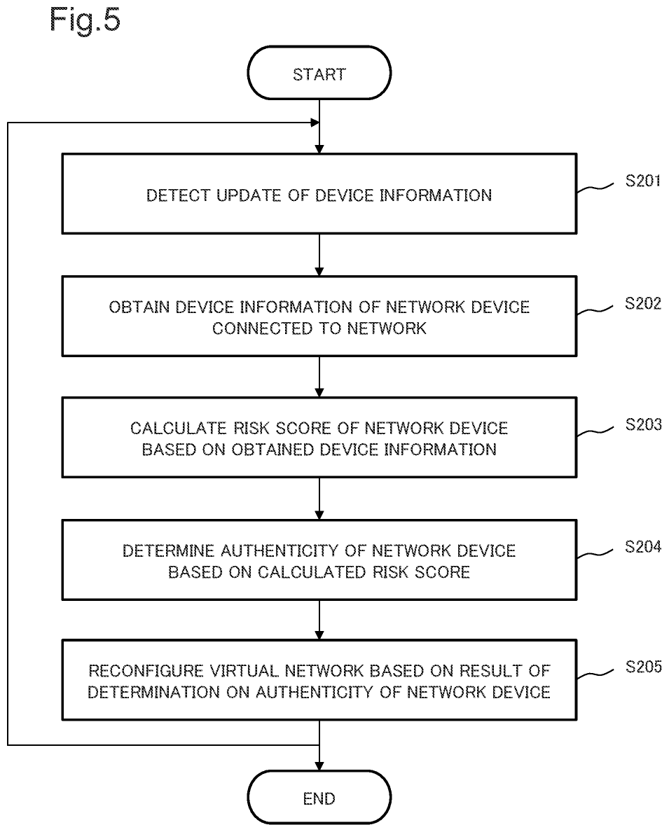

Operation of the network configuration device 110 configured as described above will be described with reference to a flowchart of FIG. 5.

FIG. 5 is a flowchart illustrating an outline of the operation of the network configuration device 110 according to the second example embodiment. The process according to this flowchart may be executed based on program control by the processor described above.

As illustrated in FIG. 5, first, when the device information acquisition unit 111 detects an update of the device information in the device information storage device 310 (step S201), it obtains the device information of the network device connected to the network (step S202). Next, the risk score calculation unit 112 calculates a risk score of the network device based on the device information obtained by the device information acquisition unit 111 (step S203). Next, the authenticity determination unit 113 determines the authenticity of the network device based on the calculated risk score (step S204). Finally, the network configuration unit 114 reconfigures the virtual network based on the authenticity result determined by the authenticity determination unit 113 (step S205). The network configuration device 110 repeats the series of processing each time an update of the device information in the device information storage device 310 is detected. The network configuration device 110 then terminates the operation of the network configuration.

According to the second example embodiment of the present disclosure, the authenticity determination unit 113 determines the authenticity of the network device based on the calculated risk score, and the network configuration unit 114 reconfigures the virtual network based on the determined authenticity result. As a result, it becomes possible to finely set conditions for the authenticity of the network device to be reconfigured. According to the second example embodiment of the present disclosure, the network configuration unit 114 reconfigures the virtual network based on the authenticity determination result by the authenticity determination unit 113 when the device information of the network device is updated. As a result, it becomes possible to ensure the network security even in a case where the authenticity of the network device is impaired after the virtual network is configured.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, while the plurality of operations are described in order in the form of a flowchart, the order of the description does not limit the execution order of the plurality of operations. Thus, when the example embodiments are implemented, the order of the plurality of operations may be changed to the extent that does not interfere with the contents. In the present example embodiment, the authenticity determination unit 113 determines the authenticity of the network device based on the risk score calculated by the risk score calculation unit 112, and the network configuration unit 114 reconfigures the virtual network based on the authenticity result determined by the authenticity determination unit 113. However, the authenticity determination unit 113 may not determine the authenticity based on the risk score calculated by the risk score calculation unit 112. That is, in a similar manner to the authenticity determination unit 102 according to the first example embodiment, the authenticity may be determined based on the device information obtained by the device information acquisition unit 111, and the network configuration unit 114 may reconfigure the virtual network based on the determined authenticity. Moreover, the network configuration unit 114 may reconfigure the virtual network based on the risk score calculated by the risk score calculation unit 112 (e.g., order of scores of the risk score). That is, in the second example embodiment, the authenticity determination unit 113 may not be included. Moreover, while the risk score calculation unit 112 scores the authenticity of the various types of device information based on the device information, it may obtain, from the network device, information (authenticity individual information) in which the authenticity of the various types of device information is scored.

In the example embodiments, a means that assigns a communication function necessary for a communication service to the virtual network configured by the network configuration units 103 and 114 may be further included.

### REFERENCE SIGNS LIST

10, 11 information system
100, 110 network configuration device
101, 111 device information acquisition unit
102, 113 authenticity determination unit
103, 114 network configuration unit
112 risk score calculation unit
200 service slicing management device
300 device information storage device

What is claimed is:

1. A network configuration device comprising:
a memory storing instructions; and
at least one processor configured to execute the instructions to:
obtain device information in which a configuration and a risk regarding a network device connected to a physical network are visualized;
determine authenticity of the network device based on the obtained device information; and
configure a virtual network on the physical network based on a result of the determination on the authenticity of the network device.

2. The network configuration device according to claim 1, wherein the at least one processor is further configured to execute the instructions to:
configure the virtual network using only the network device determined to have the authenticity.

3. The network configuration device according to claim 1, wherein the device information obtained includes different types of information of configuration information, event information, and inspection information of the network device.

4. The network configuration device according to claim 3, wherein the at least one processor is further configured to execute the instructions to:
obtain pieces of authenticity individual information determined from pieces of the different types of the device information, and
determine the authenticity of the network device based on the obtained authenticity individual information.

5. The network configuration device according to claim 1, wherein the at least one processor is further configured to execute the instructions to:
calculate a risk score that represents a degree of the authenticity, and
determine the authenticity of the network device based on the calculated risk score.

6. The network configuration device according to claim 1, wherein the at least one processor is further configured to execute the instructions to:
obtain the device information when the device information of the network device included in the virtual network is updated,
determine the authenticity of the network device based on the obtained device information after the update, and
to configure the virtual network based on a result of the determination on the authenticity of the network device after the update.

7. The network configuration device according to claim 1, wherein the at least one processor is further configured to execute the instructions to:
assign a communication function of the network device included in the virtual network to the virtual network.

8. An information system including:
a network configuration device;
a service slicing management device configured to manage and control the network configuration device; and
a device information storage device configured to store device information in which a configuration and a risk regarding a network device connected to a physical network are visualized, wherein
the network configuration device comprising:
a memory storing instructions; and
at least one processor configured to execute the instructions to:
obtain the device information from the device information storage device;
determine authenticity of the network device based on the obtained device information; and
configure a virtual network on the physical network based on a result of the determination on the authenticity of the network device.

9. A network configuration method comprising:
obtaining device information in which a configuration and a risk regarding a network device connected to a physical network are visualized;
determining authenticity of the network device based on the obtained device information; and
configuring a virtual network on the physical network based on a result of the determination on the authenticity of the network device.

10. A non-transitory computer readable recording medium storing a program for causing a computer to perform:
obtaining device information in which a configuration and a risk regarding a network device connected to a physical network are visualized;
determining authenticity of the network device based on the obtained device information; and
configuring a virtual network on the physical network based on a result of the determination on the authenticity of the network device.
